(19) United States
(12) Patent Application Publication
(10) Pub. No.: US 2018/0068329 A1
(43) Pub. Date: Mar. 8, 2018

(54) PREDICTING REAL PROPERTY PRICES USING A CONVOLUTIONAL NEURAL NETWORK

(71) Applicant: International Business Machines Corporation, Armonk, NY (US)

(72) Inventors: Raghu K. Ganti, Elmsford, NY (US); Swati Rallapalli, Ossining, NY (US); Mudhakar Srivatsa, White Plains, NY (US)

(73) Assignee: International Business Machines Corporation, Armonk, NY (US)

(21) Appl. No.: 15/255,687

(22) Filed: Sep. 2, 2016

(51) Int. Cl. G06Q 30/02; G06N 5/02; G06K 9/66; G06K 9/46; G06T 11/60

(52) U.S. Cl. CPC G06Q 30/0202; G06N 5/02; G06Q 50/16; G06K 9/4604; G06T 11/60; G06K 9/66

(57) ABSTRACT

A subset of a set of image data is input into a trained convolutional neural network (CNN), the subset of image data including several of digital images, each image including a depiction of a real estate property at a different zoom level. By executing the CNN, a set of features is extracted from the subset of image data, a feature in the set of features being unrepresented in the subset of image data, and where the feature is derived from a depiction in the subset of image data. Using a set of node values configured at a set of nodes in a layer of the CNN, and using the set of features, a combined value of the set of features is computed, relative to the real estate property. A predicted price of the real estate property is predicted, by executing the CNN, using the combined value.

### GOVERNMENT RIGHTS

This invention was made with Government support under Contract No.: W911NF-09-2-0053 awarded by Army Research Office (ARO). The Government has certain rights in this invention.

### TECHNICAL FIELD

The present invention relates generally to a method, system, and computer program product for making price predictions for real estate. More particularly, the present invention relates to a method, system, and computer program product for predicting real property prices using a convolutional neural network.

### BACKGROUND

Hereinafter, “real property” and “property” are interchangeably used to refer to real estate of any kind, that can be bought, sold, or otherwise transacted, unless expressly disambiguated where used.

An image is a digital representation or facsimile of a physical object or a collection of physical objects. Technology presently exists to detect or recognize certain objects that are present in a given image. For example, a digital camera can recognize that objects, such as human faces or human eyes, are present in an image created by the camera lens on the sensor of the camera. Photo editing software can recognize that objects, such as straight lines, are present in an image being edited.

Generally, the present technology for object detection in images relies upon identifying those features of those objects for which such technology has been programmed. Stated another way, an existing image processing engine will only recognize certain objects by identifying certain features of those objects, where the engine is pre-programmed to identify the features described in a file or repository of features that is associated with the engine. There is a specific syntax in which the features are described in such a file, the engine reads the syntactic definition of a feature from the file, the engine compares image pixels with the defined feature, and the engine finds an acceptable match between a defined feature from the file and certain pixel arrangements in the given image.

### SUMMARY

The illustrative embodiments provide a method, system, and computer program product. An embodiment includes a method that inputs a subset of a set of image data into a trained convolutional neural network (CNN), wherein the subset of image data includes a plurality of digital images, each image in the plurality including a depiction of a real estate property at a different zoom level. The embodiment extracts, by executing the CNN using a processor and a memory, a set of features from the subset of image data, a feature in the set of features being unrepresented in the subset of image data, and wherein the feature is derived from a depiction in the subset of image data. The embodiment computes, using a set of node values configured at a set of nodes in a layer of the CNN, and using the set of features, a combined value of the set of features relative to the real estate property. The embodiment predicts, by executing the CNN, using the combined value, a predicted price of the real estate property.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example manner of using a CNN for price prediction of real estate in accordance with an illustrative embodiment;

FIG. 4 depicts a block diagram of an example configuration for predicting real property prices using a convolutional neural network in accordance with an illustrative embodiment; and

FIG. 5 depicts a flowchart of an example process for predicting real property prices using a convolutional neural network in accordance with an illustrative embodiment.

### DETAILED DESCRIPTION

Presently, the real estate pricing models rely upon a static matrix of features that are known to influence real properties in a given subdivision. Generally, the features considered in the matrix are local to a relatively small area, such as a city block, surrounding the property in question.

Within this small area, the well-known features considered by prospective buyers today include the condition of the property itself, the type of schools to which the property is zoned, accessibility of recreation and transportation from the property, upkeep level of the neighborhood, pricing of similar properties in the neighborhood, and the like. Presently, all such features are limited to the small area immediately surrounding the property.

The illustrative embodiments recognize that a price of a real property is dependent upon a variety of features that can be geo-spatially removed from a property that is to be priced. For example, the illustrative embodiments recognize that for pricing a property, some features are relevant at a small distance from the property, such as within a city block of the property; some features are relevant at a medium distance from the property, such as within a mile of the property; and some features are relevant at a large distance from the property, such as within ten mile of the property.

In other words, different features are relevant to the price of a property at different granularities, or distances. The presently available methods for pricing real property, such as the static matrix of feature weights, are not configured in a manner to account for features at different granularities that affect the price.

Furthermore, the illustrative embodiments recognize that many features are not clearly identifiable for weighting into a matrix. For example, a lake at five miles of distance from a property affects the price of the property differently when the property is located in one geographical area versus in another geographical area. While the mere presence of the lake may be weighted in a matrix, the various effects the presence of the lake has on the property are neither so clearly discernible, quantifiable, or weighable in the matrix, nor are same from geographical location to geographical location.

The illustrative embodiments recognize that people, on the other hand, do subconsciously recognize such indirect and variable features, and attribute value to them in offering a price for a property. The presently available methods for pricing real property, such as the static matrix of feature weights, are not configured in a manner to account for such indirect and variable features, which can occur at different granularities from the property to be priced.

The illustrative embodiments used to describe the invention generally address and solve the above-described problems and other problems related to predicting real property prices using a convolutional neural network.

An embodiment can be implemented as a software application. The application implementing an embodiment can be configured as a modification of an existing real property pricing or management system, as a separate application that operates in conjunction with an existing real property pricing or management system, a standalone application, or some combination thereof.

Real properties can be photographed from satellites orbiting outside Earth's atmosphere, from aircrafts, or both. An aerial photograph of a property—whether taken from a satellite or an aircraft—can show not only the property but features of the surrounding area at different distances. In terms of an aerial photograph of a property, a granularity of the photograph is a measure of a distance covered in the photograph relative to the property in the photograph. For example, at one granularity, a picture might depict just the structure of the property and no other significant feature. At another example granularity, a picture might depict the structure of the property and immediately adjacent features of the property, such as a backyard and a swimming pool adjacent to the property. At another example granularity, a picture might depict the structure of the property, immediately adjacent features of the property, one or more other structures and features, and some pathways in a half-mile radius from the property. At another example granularity, a picture might depict the structure of the property and features—albeit in not great detail, numerous other structures, terrain, and many types of pathways in a two-mile radius from the property. As can be seen, pictures of various granularities are possible to show or include different features at different distances from the property in question.

These examples of distances and granularities are not intended to be limiting. From this disclosure, those of ordinary skill in the art will be able to conceive many other distances and granularities and the same are contemplated within the scope of the illustrative embodiments.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

In machine learning, a convolutional neural network (CNN) is a type of feed-forward artificial neural network. A feedforward neural network is an artificial neural network where connections between the node units do not form a loop or a cycle. The connectivity pattern between the nodes of a CNN (neurons) is inspired by the organization of the animal visual cortex, whose individual neurons are arranged to respond to overlapping regions tiling a visual field. Convolutional networks mimic biological processes and are configured as variations of multilayer perceptrons designed to use minimal amounts of preprocessing while processing data, such as digital images.

A CNN is configured with overlapping “reception fields” performing convolution tasks. A CNN is particularly efficient in recognizing image features, such as by differentiating pixels or pixel regions in a digital image from other pixels or pixel regions in the digital image. Generally, a CNN is designed to recognize images or parts of an image, such as detecting the edges of an object recognized on the image. Computer vision is a field of endeavor where CNNs are commonly used.

A CNN according to an embodiment can include any number of convolution layers and any number of fully connected layers. An embodiment trains a CNN with sets of training data. Each set of training data includes the following—a plurality of pictures of a training property where each picture in the plurality is at a different zoom level and therefore of a different granularity, and pricing data of the training property. The training property is an actual or fictitious property that has been bought, sold, or has otherwise been the subject of a financial transaction or estimation at a past time. A set of granularities can be predetermined such that each set of training data includes a picture at one of the predetermined granularities in the set of granularities.

Each set of training data pertains to a different training property. Each training property is physically located, or configured to be located within a geographical area that is defined for a particular training session. Furthermore, not all sets of training data need include exactly the same number of pictures in their respective pluralities of pictures.

An embodiment trains a CNN using the sets of training data. During the training process, some convolution layers of the CNN extract various features from the pictures in the sets of training data. For example, the extracted features include indirect and variable features that contribute to or deduct from the actual or estimated price of the training properties in some respect. Of course one or more direct features that can be configured into a prior-art matrix can also be included in the extracted features, but the extracted features are not limited to just such direct features.

Some non-limiting examples of the features include names of one or more other properties (e.g., XYZ stadium or ABC memorial plaza etc.) situated relative to the real property in question in a picture, a type of one or more other properties (e.g., school, arena, railroad, museum, etc.) situated relative to the real property in question in a picture, a type of activity performed at one or more other properties (e.g., educational, sports, entertainment, etc.) situated relative to the real property in question in a picture, or some combination thereof. These and other features can be extracted from a given set of pictures, obtained from other sources such as point of interest data sources, or a combination thereof.

Further during the training, some layers, e.g., a fully connected layer in the CNN, fuses the extracted features with the pricing data according to some stabilized node values in the layer or layers. In other words, given the training sets of pictures the CNN learns to output the corresponding pricing data within a defined tolerance value. The pricing data in the training data can be obtained from any source that maintains or provides pricing data on real estate properties, including but not limited to real estate marketing websites and their associated databases.

Fusing is the process of combining more than one values into a singular value, such as according to a function or a relationship described or encoded in code. Within the scope of the illustrative embodiments, the features extracted from the set of pictures can be fused among themselves, and/or the features extracted from the set of pictures can be fused with a different set of features available or extracted from a source other than the pictures. Some non-limiting examples of the other set of features that can be obtained and fused in this manner include information about the real property, such as the square footage of the structure, number of rooms or usable areas, year of construction, deed restrictions, type of construction, and so on.

A CNN is considered trained for the defined geographical area and according to the sets of training data when the CNN node values have settled in such a way that for at least a threshold portion of the sets of training data, the CNN is able to accept the plurality of pictures pertaining to a training property and predict a price for the training property where the predicted price is within the tolerance value of the pricing data of that training property.

An embodiment uses the trained CNN to predict a price of a property in question. The property in question is located in the same geographical area for which the CNN has been trained.

For example, the embodiment receives a set of pictures of the property at different granularities. If a picture in the set is not of a granularity defined in the predetermined set of granularities used in the training data, then the embodiment optionally adjusts the granularity of the picture. For example, an embodiment adjusts a granularity of a picture by digitally manipulating a zoom level of the picture until a zoom level produces a predetermined granularity.

It may be that the set of pictures of the property include some pictures at various predetermined granularity and some picture of granularities other than the predetermined granularities. In such a case, an embodiment selects a subset of pictures in which each picture has a granularity that is within a tolerance value of a predefined granularity from the set of predefined granularities used in the training data.

The embodiment inputs the selected pictures of the property into the trained CNN. The embodiment obtains a price of the property from the trained CNN in response to the input pictures. The output price forms the price prediction for the property. The CNN accounts for the direct, indirect, and variable features that may be applicable to the property in producing the predicted price.

The manner of predicting real property prices using a convolutional neural network described herein is unavailable in the presently available methods. A method of an embodiment described herein, when implemented to execute on a device or data processing system, comprises substantial advancement of the functionality of that device or data processing system in predicting a price of a real property by accounting for indirect and variable features that cannot be configured or programmed into a static matrix of weights in a prior-art pricing model.

The illustrative embodiments are described with respect to certain types of properties, geographical areas, granularities, distances, zoom levels, aerial pictures, pricing data, training data, thresholds, tolerances, neural networks and their layers, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

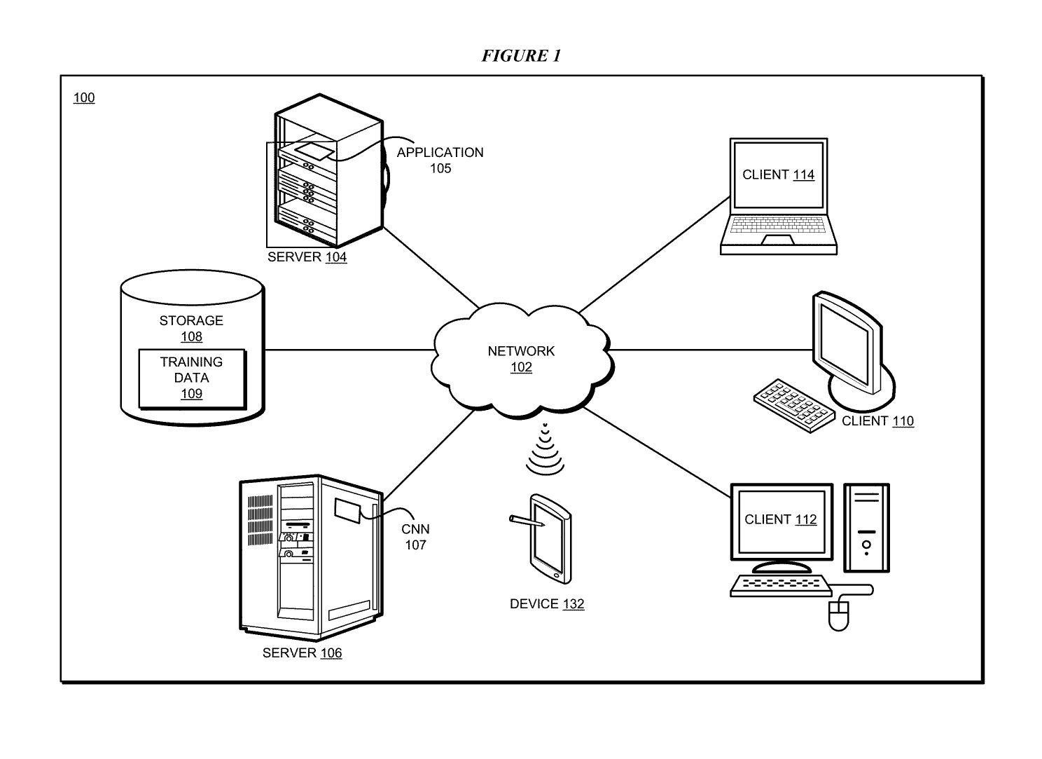

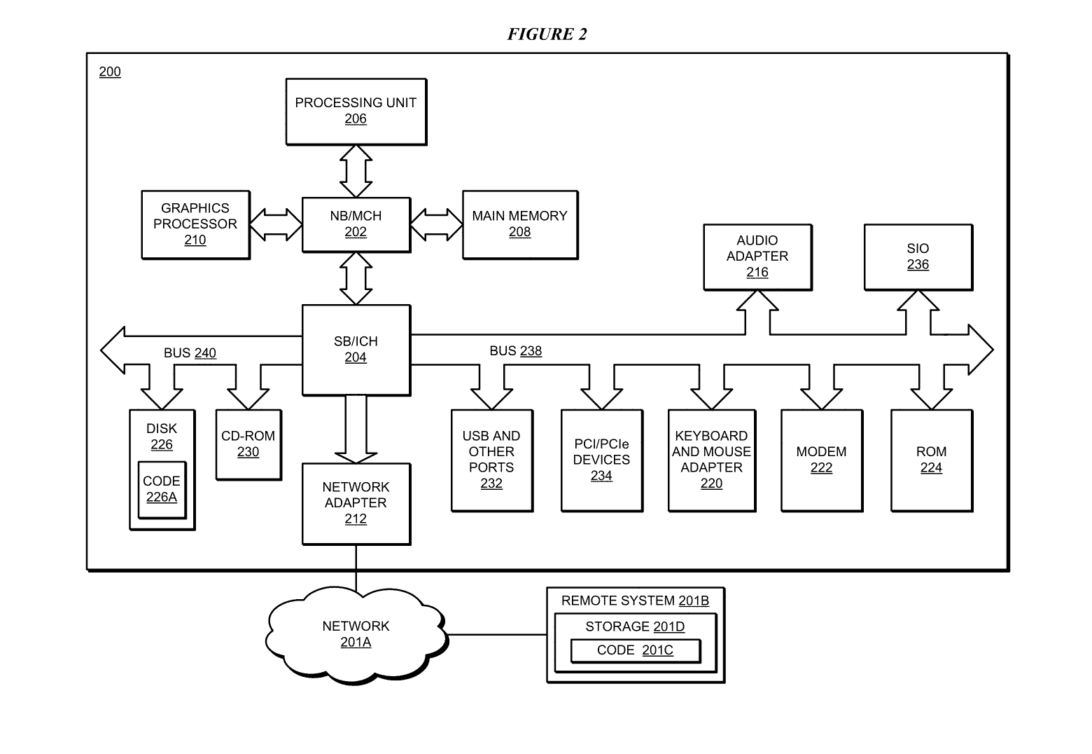

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 uses training data 109 to train CNN 107 for predicting a price of a real property in a manner described herein.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

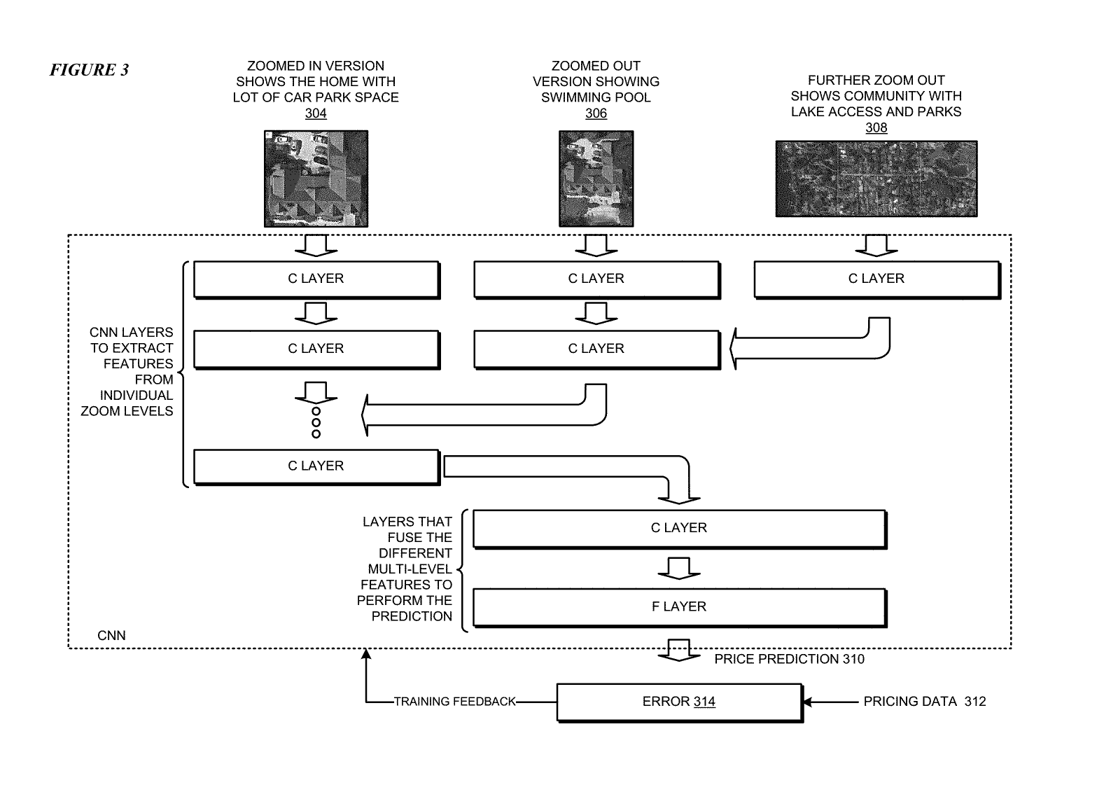

With reference to FIG. 3, this figure depicts a block diagram of an example manner of using a CNN for price prediction of real estate in accordance with an illustrative embodiment. CNN 302 is an example of CNN 107 in FIG. 1.

CNN 302 comprises any number of convolution layers or “C layers”. A C layer includes a set of nodes such that each node in the set is connected to a subset of nodes of one adjacent layer, and a subset of the nodes from the C layer are connected to a node of another adjacent layer. A C layer is particularly configured for feature extraction from image data.

A CNN also often, but not necessarily, comprises one or more fully connected layer or “F layer”. An F layer includes a set of nodes in which each node is connected to each node in another set of nodes of an adjacent layer.

A non-limiting example arrangement of C layers and an F layer are shown in CNN 302. Pictures 304, 306, and 308 are example pictures of different predetermined granularity of an example training property. For example, picture 304 is at a zoom level of granularity that is sufficient to show the property and the included car parking space; picture 306 is at a zoom level of granularity that is sufficient to show the property and the adjacent swimming pool feature; and picture 308 is at a zoom level of granularity that is sufficient to show the property, several other properties, roadways, a park and a lake that are several houses away from the training property.

When input 304 is applied to CNN 302, one or more C layer extracts one or more indirect or variable feature about the training property. When input 306 is applied to CNN 302, one or more C layer extracts one or more indirect or variable feature about the training property and its immediate surroundings. When input 308 is applied to CNN 302, one or more C layer extracts one or more indirect or variable feature about the training property and its distant surroundings. In one embodiment, the same C layers may extract these features from inputs 304, 306, and 308. In another embodiment, different C layers may extract these features from inputs 304, 306, and 308.

A combination of one or more C layers and optionally one or more F layer combine the extracted features to produce prediction 310 about the price of the training property in pictures 304-308. Pricing data 312 is obtained from a suitable source of real estate price or estimate information. Error 314 is a difference between pricing data 312 and predicted price 310. Error 314 is fed back to CNN 302 in the training process. CNN 302 adjusts the node values in one or more layers in CNN 302 in an attempt to minimize error 314. When error 314 is reduced to at or below a threshold value, CNN 302 is considered trained.

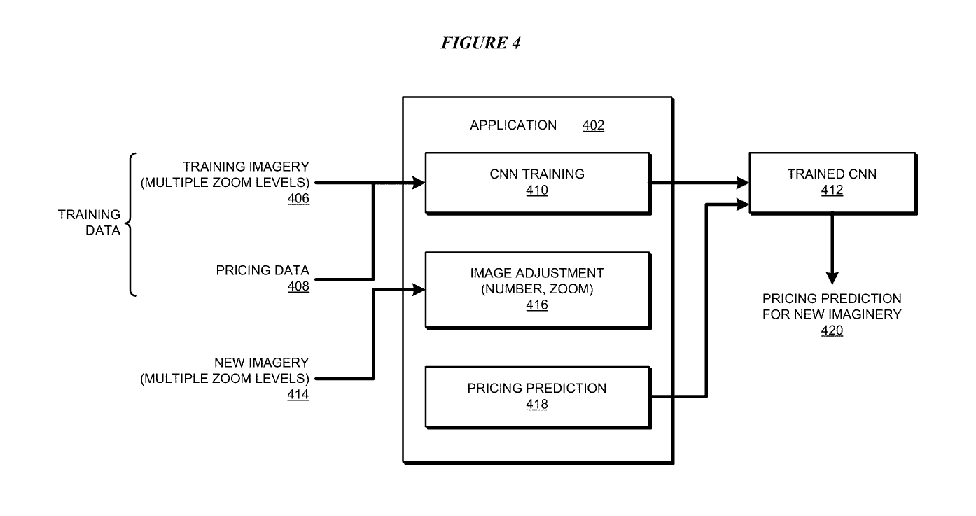

With reference to FIG. 4, this figure depicts a block diagram of an example configuration for predicting real property prices using a convolutional neural network in accordance with an illustrative embodiment. Application 402 is an example of application 105 in FIG. 1. Training date 404 is an example of training data 109 in FIG. 1. For example, training data 404 includes image data 406 at multiple zoom levels or granularity, such as images 304, 306, and 308 in FIG. 3, and pricing data 408, such as pricing data 312 in FIG. 3. Component 410 trains a CNN using training data 404 in the manner described herein, and produces trained CNN 412.

New imagery 414 includes image data collected at multiple zoom levels or granularity. New imagery 414 is of a property whose price is to be predicted. As described herein, under certain circumstances new imagery 414 may not include image data at a predetermined granularity, or may include image data at granularity that is not needed. In such cases, component 416 adjusts a granularity of an image, or selects a subset of new imagery 414 to construct input data for trained CNN 412. Component 418 uses the constructed input data from component 416, or new imagery 414 if new imagery need not be modified, and provides as input to trained CNN 412. Trained CNN 412 produces price prediction 420 corresponding to new imagery 414.

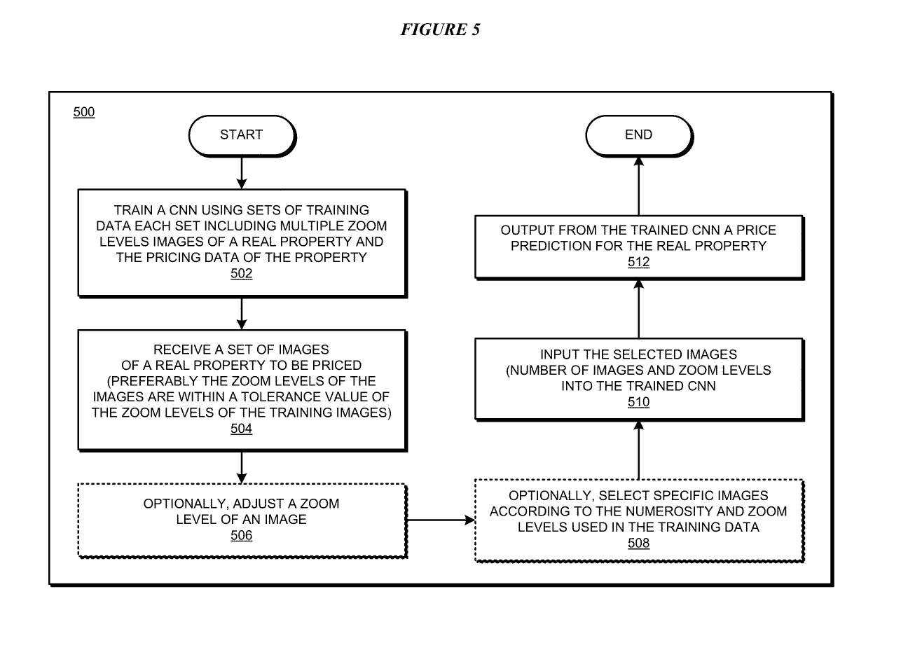

With reference to FIG. 5, this figure depicts a flowchart of an example process for predicting real property prices using a convolutional neural network in accordance with an illustrative embodiment. Process 500 can be implemented in application 402 in FIG. 4.

The application trains a CNN using sets of training data, each set including images of a training property at multiple zoom levels and the pricing data of the training property (block 502). The application produces a trained CNN.

The application receives a set of images of a property for which a price is to be predicted (block 504). Preferably, the set of images includes images configured at substantially the same or similar zoom levels as the training data images. When the set of images from block 504 includes an image whose zoom level is significantly different from a zoom level in the training data, the application optionally adjusts, or digitally manipulates, the zoom level such that the adjusted zoom level is substantially the same or similar zoom level of a training data image (block 506).

When the set of images in block 504 includes more images than are usable with the trained CNN, the application optionally selects a subset of the images according to the numerosity of the training images and/or the zoom levels of the training images used for a training property in the training data (block 508).

The application inputs the set, or the selected subset, or the selected/adjusted subset of images from blocks 504-508, as the case may be, in the trained CNN (block 510). The application outputs from the trained CNN a prediction of a price of the property whose images are received at block 504 (block 512). The application ends process 500 thereafter.

Thus, a computer implemented method, system or apparatus, and computer program product are provided in the illustrative embodiments for predicting real property prices using a convolutional neural network and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
inputting a subset of a set of image data into a trained convolutional neural network (CNN), wherein the subset of image data includes a plurality of digital images, each image in the plurality including a depiction of a real estate property at a different zoom level;
extracting, by executing the CNN using a processor and a memory, a set of features from the subset of image data, a feature in the set of features being unrepresented in the subset of image data, and wherein the feature is derived from a depiction in the subset of image data;
computing, using a set of node values configured at a set of nodes in a layer of the CNN, and using the set of features, a combined value of the set of features relative to the real estate property; and
predicting, by executing the CNN, using the combined value, a predicted price of the real estate property.

2. The method of claim 1, further comprising:
providing a training set of image data to the CNN;
configuring the set of nodes in the layer of the CNN to extract from the training data a feature in the set of features;
fusing, in the CNN, the set of features from the training data to form a fused feature; and
predicting, using the fused feature, a price of a training real estate property depicted in the training set of image data.

3. The method of claim 2, further comprising:
changing, responsive to an error value between the predicted price and a pricing data exceeding a threshold, a configuration of a node in the set of nodes; and
predicting a second price of the training real estate property, wherein the CNN becomes the trained CNN responsive to a second error value between the second predicted price and the pricing data not exceeding the tolerance value.

4. The method of claim 1, further comprising:
adding, to the subset of image data, from the set of image data, a first digital image wherein a first zoom level of the first digital image is within a tolerance value of a second zoom level of a training image used to train the trained CNN; and
omitting, from the subset of image data, a second digital image in the set of image data, wherein a third zoom level of the second digital image is different from a fourth zoom level of a training image used to train the trained CNN by more than the tolerance value.

5. The method of claim 1, further comprising:
selecting from the set of image data a digital image;
changing a zoom level of the digital image from an original zoom level of the digital image to a second zoom level, the second zoom level being used in a training image used to train the trained CNN, the changing forming a modified digital image; and
adding the modified digital image into the subset of image data.

6. The method of claim 1, wherein the subset of image data comprises the entire set of image data.

7. The method of claim 1, wherein the trained CNN comprises a set of layers, the set of layers including the layer and a second layer, the second layer comprising a second set of nodes, and wherein a node in the set of nodes in the layer is connected to receive inputs from a subset of the second set of nodes in the second layer.

8. The method of claim 1, wherein a second feature in the set of features in the subset of image data comprises a type of a second real estate property situated relative to the real estate property.

9. The method of claim 8, wherein the type is a type of activity conducted at the second real estate property.

10. The method of claim 1, further comprising:
fusing the set of features with a second set of features to form a fused feature, the fusing combining the set of features and the second set of features according to a function to result in a single value of the fused feature, and wherein the second set of features correspond to the real estate property and is obtained from a source other than the set of image data.

11. A computer usable program product comprising one or more computer-readable storage devices, and program instructions stored on at least one of the one or more storage devices, the stored program instructions comprising:
program instructions to input a subset of a set of image data into a trained convolutional neural network (CNN), wherein the subset of image data includes a plurality of digital images, each image in the plurality including a depiction of a real estate property at a different zoom level;
program instructions to extract, by executing the CNN using a processor and a memory, a set of features from the subset of image data, a feature in the set of features being unrepresented in the subset of image data, and wherein the feature is derived from a depiction in the subset of image data;
program instructions to compute, using a set of node values configured at a set of nodes in a layer of the CNN, and using the set of features, a combined value of the set of features relative to the real estate property; and
program instructions to predict, by executing the CNN, using the combined value, a predicted price of the real estate property.

12. The computer usable program product of claim 11, further comprising:
program instructions to provide a training set of image data to the CNN;
program instructions to configure the set of nodes in the layer of the CNN to extract from the training data a feature in the set of features;
program instructions to fuse, in the CNN, the set of features from the training data to form a fused feature; and
program instructions to predict, using the fused feature, a price of a training real estate property depicted in the training set of image data.

13. The computer usable program product of claim 12, further comprising:
program instructions to change, responsive to an error value between the predicted price and a pricing data exceeding a threshold, a configuration of a node in the set of nodes; and
program instructions to predict a second price of the training real estate property, wherein the CNN becomes the trained CNN responsive to a second error value between the second predicted price and the pricing data not exceeding the tolerance value.

14. The computer usable program product of claim 11, further comprising:
program instructions to add, to the subset of image data, from the set of image data, a first digital image wherein a first zoom level of the first digital image is within a tolerance value of a second zoom level of a training image used to train the trained CNN; and
program instructions to omit, from the subset of image data, a second digital image in the set of image data, wherein a third zoom level of the second digital image is different from a fourth zoom level of a training image used to train the trained CNN by more than the tolerance value.

15. The computer usable program product of claim 11, further comprising:
program instructions to select from the set of image data a digital image;
program instructions to change a zoom level of the digital image from an original zoom level of the digital image to a second zoom level, the second zoom level being used in a training image used to train the trained CNN, the changing forming a modified digital image; and
program instructions to add the modified digital image into the subset of image data.

16. The computer usable program product of claim 11, wherein the subset of image data comprises the entire set of image data.

17. The computer usable program product of claim 11, wherein the trained CNN comprises a set of layers, the set of layers including the layer and a second layer, the second layer comprising a second set of nodes, and wherein a node in the set of nodes in the layer is connected to receive inputs from a subset of the second set of nodes in the second layer.

18. The computer usable program product of claim 11, wherein the computer usable code is stored in a computer readable storage device in a data processing system, and wherein the computer usable code is transferred over a network from a remote data processing system.

19. The computer usable program product of claim 11, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to input a subset of a set of image data into a trained convolutional neural network (CNN), wherein the subset of image data includes a plurality of digital images, each image in the plurality including a depiction of a real estate property at a different zoom level;
program instructions to extract, by executing the CNN using a processor and a memory, a set of features from the subset of image data, a feature in the set of features being unrepresented in the subset of image data, and wherein the feature is derived from a depiction in the subset of image data;
program instructions to compute, using a set of node values configured at a set of nodes in a layer of the CNN, and using the set of features, a combined value of the set of features relative to the real estate property; and
program instructions to predict, by executing the CNN, using the combined value, a predicted price of the real estate property.
